(19) United States
(12) Patent Application Publication
(10) Pub. No.: US 2013/0171425 A1
(43) Pub. Date: Jul. 4, 2013

(54) GLASS ARTICLE AND METHOD FOR MAKING SAME

(71) Applicants: REN-BO WANG, Shenzhen City (CN); XIN-WU GUAN, Shenzhen City (CN)

(72) Inventors: REN-BO WANG, Shenzhen City (CN); XIN-WU GUAN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/485,094

(22) Filed: May 31, 2012

(30) Foreign Application Priority Data
Dec. 29, 2011 (CN) 201110450410.2

(51) Int. Cl. B32B 3/08; C03C 17/00; C03C 21/00; C03B 23/023; C03C 15/00

(52) U.S. Cl. 428/172; 65/106; 65/31; 65/30.14; 65/60.1; 65/60.3

(57) ABSTRACT

A glass article includes a main body made from glass and at least one decorative member. The main body has a three-dimensional shape and has an outer surface which has at least one curved surface portion. The at least one curved surface portion defines at least one recess. The at least one decorative member are received in the corresponding at least one recess to form a desired symbol, logo, or pattern on the glass article. A method for making the glass article is also provided.

### BACKGROUND

1. Technical Field

The present disclosure relates to glass articles and a method for making the glass articles with three-dimensional patterns or logos.

2. Description of Related Art

Electronic devices, such as cellular phones often have glass display windows or glass touching panels. These glass members are usually decorated with logos or patterns. A method for making these decorations on a glass member includes employing laser etching or chemical etching a two-dimensional surface of the glass member. However, the decorations created by such method are formed on a two-dimensional surface and have insufficient three-dimensional effect.

Therefore, there is room for improvement within the art.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings like reference numerals designate corresponding parts throughout the views.

FIG. 1 is a perspective view of the present glass article according to an exemplary embodiment.

FIG. 2 is a cross-sectional view of the glass article show in FIG. 1 taken along line II-II.

### DETAILED DESCRIPTION

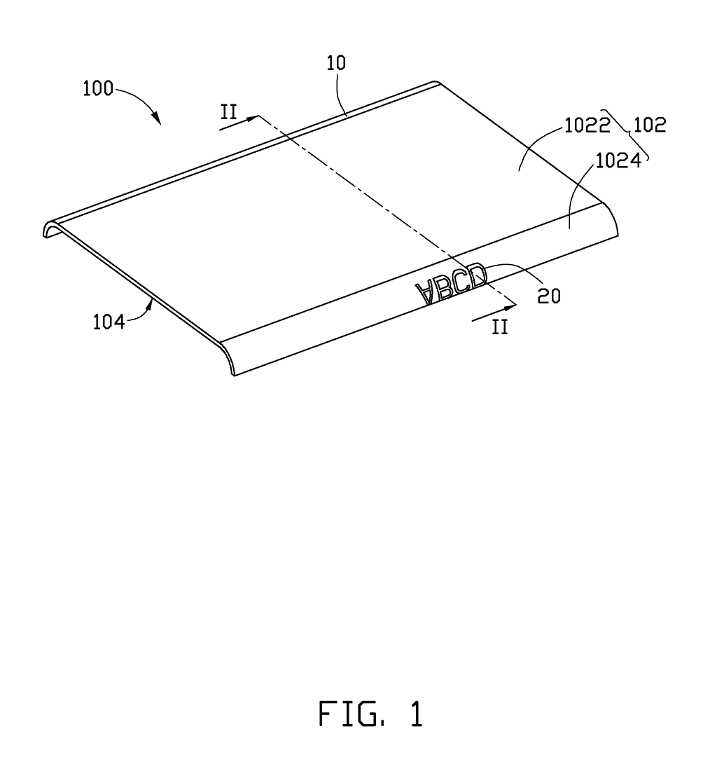

FIG. 1 shows an exemplary glass article 100. The glass article 100 can be a display window or housing for electronic devices, such as mobile phones and MP3 players. In the exemplary embodiment, the glass article 100 is a display window of a mobile phone. The glass article 100 includes a main body 10 made of glass and at least one decorative member 20. The main body 10 has at least one recess 15. In the exemplary embodiment, the main body 10 includes a plurality of recesses 15, and the glass article 100 includes a plurality of decorative members 20. The decorative members 20 are positioned within the recesses 15 of the main body 10 to form a desired symbol, logo, or pattern.

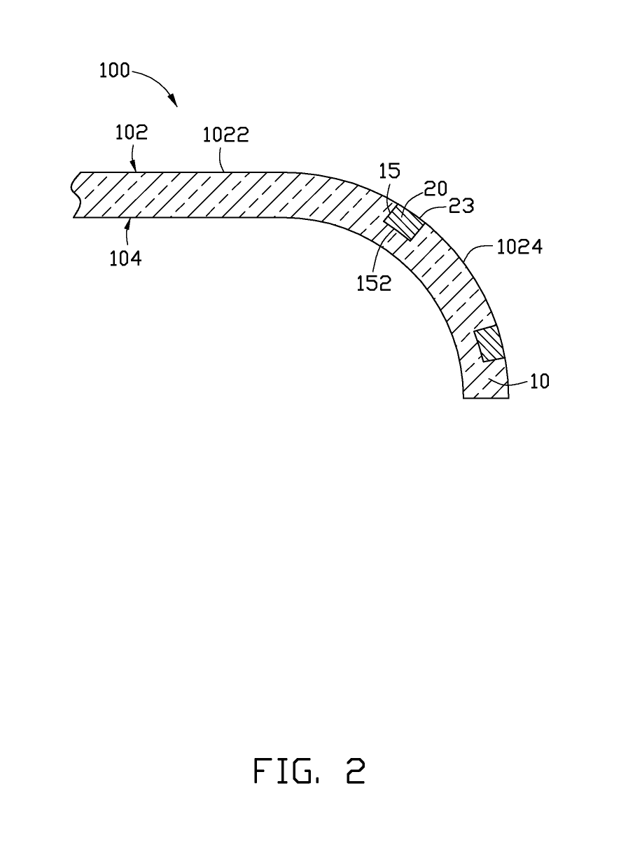

Referring to FIG. 2, the main body 10 has a desired three-dimensional (3D) shape (not two-dimensional shape such as a plate). The main body 10 has an outer surface 102 and an inner surface 104 opposite to the outer surface 102. The outer surface 102 includes at least one curved surface portion 1024, such as an arcuate surface portion. In the exemplary embodiment, the outer surface 102 includes one flat portion 1022 and two curved surface portions 1024 extending from two opposite ends of the flat portion 1022, respectively. The recesses 15 are defined in one of the curved surface portions 1024. Bottom surfaces 152 of the recesses 15 have a surface roughness Ra of about 0.8 micrometers (μm) to about 1.0 μm, which improves the adhesiveness of the decorative members 20. The recesses 15 cooperatively form a desired symbol, logo, or pattern on the outer surface 102. The recesses 15 cooperatively receive the decorative members 20.

Each decorative member 20 has a shape and size generally corresponding to the corresponding recess 15, accordingly, the decorative members 20 can be received in the recesses 15. The decorative members 20 may be made from a material selected from the group consisting of metal (such as stainless steel), wood, enamel, and plastic. In the case of a material selected from the group consisting of metal, wood, and plastic, the decorative members 20 can be secured in the recesses 15 by adhesive. In the case of an enamel material, the decorative members 20 can be directly formed in the recesses 15.

When the decorative members 20 are received in the recesses 15, top surfaces 23 of the decorative members 20 may be lower than the outer surface 102 or be flushed with the outer surface 102. In the exemplary embodiment, the top surface 23 of the decorative members 20 are substantially flushed with the outer surface 102.

An exemplary method for making the glass article 100 may include the following steps.

A flat glass sheet (not shown) is provided.

The flat glass sheet is cut into a desired size for the glass article 100. This step may be omitted if the flat glass sheet is provided with a desired size.

The at least one recess 15 is formed in a selected portion of the cut flat glass sheet where is to be shaped into 3D structure. The at least one recess 15 can be formed by chemical etching or laser engraving, for example.

The bottom surface 152 of the at least one recess 15 is roughened to improve the surface roughness of the bottom surface 152. Roughening the bottom surface 152 may use sand blasting or chemical etching. The roughened bottom surface 152 has a surface roughness Ra of about 0.8 μm to about 1.0 μm.

The flat glass sheet is treated by a heat bending process to form a desired shape, thereby creating the main body 10. The main body 10 has the outer surface 102. The outer surface 102 includes at least one curved surface portion 1024. The heat bending process enable the at least one recess 15 to be located at the curved surface portion 1024. In the exemplary embodiment, the heat bending process is carried out in a glass heat bending oven (not shown). During the heat bending process, the internal temperature of the glass heat bending oven is controlled as the following manner heating up from 0° C. to 600° C. within about 20 minutes (min) to about 40 min; heating up from 600° C. to 800° C. within about 30 min to about 60 min; maintaining at 800° C. for about 30 min to about 70 min; then cooling down from 800° C. to 580° C. within 20 min to about 40 min; cooling down form 580° C. to 260° C. within 30 min to about 70 min; and naturally cooling down from 260° C. to room temperature. Each of these time periods is calculated from the end of the previous period.

The main body 10 is chemically strengthened. The main body 10 can be immersed in a molten potassium salt bath to exchange sodium ions in a surface layer of the main body 10 with potassium ions in the molten potassium salt bath, thereby enhancing the surface hardness of the main body 10. The potassium salt may be potassium nitrate. This step may be omitted if the flat glass sheet is a strengthened glass sheet.

After the chemical strengthening step, the at least one decorative member 20 is formed within the at least one recess 15, providing a desired symbol, logo, or pattern on the glass article 100. The at least one decorative member 20 may be made from a material selected from the group consisting of metal (such as stainless steel), wood, enamel, and plastic. In the case of a metal or wood material, at least one decorative member 20 can be previously manufactured from metal or wood, and then secured in the at least one recess 15 by adhesive. In the case of an enamel material, the at least one decorative member 20 can be formed by filling enamel powder in the at least one recess 15, and then sintering the enamel powder to form the at least one decorative member 20. In the case of a plastic material, the at least one decorative member 20 can be formed within the at least one recess 15 by manufacturing at least one decorative member from plastic and then securing the at least one decorative member in the at least one recess by adhesive. Alternatively, the at least one decorative member 20 can be formed within the at least one recess 15 by filling plastic powder in the at least one recess 15, and then sintering the plastic powder to form the at least one decorative member 20.

The at least one decorative member 20 of the present glass article 100 is formed in the curved surface portion 1024 (which is a 3D surface portion) of the 3D shaped main body 10, providing a 3D symbol, logo, or pattern on the glass article 100.

However, even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A glass article, comprising:
a glass three-dimensional main body, the main body having an outer surface which has at least one curved surface portion, the at least one curved surface portion defining at least one recess; and
at least one decorative member, the at least one decorative member received in the corresponding at least one recess.

2. The glass article as claimed in claim 1, wherein the outer surface includes one flat portion and two curved surface portions extending from two opposite ends of the flat portion respectively; the at least one recess is defined in one of the curved surface portions.

3. The glass article as claimed in claim 1, wherein a bottom surface of the at least one recess has a surface roughness Ra of about 0.8 μm to about 1.0 μm.

4. The glass article as claimed in claim 1, wherein the at least one decorative member is made from a material selected from the group consisting of metal, wood, enamel, and plastic.

5. The glass article as claimed in claim 4, wherein the at least one decorative member is made from a material selected from the group consisting of metal, wood, and plastic, the at least one decorative member is secured in the at least one recesses by adhesive.

6. The glass article as claimed in claim 4, wherein the at least one decorative member is directly formed in the at least one recess.

7. The glass article as claimed in claim 1, wherein a top surface of the at least one decorative member is substantially flush with the outer surface.

8. The glass article as claimed in claim 1, wherein the at least one decorative member forms a symbol, logo, or pattern on the glass article.

9. A method for making a glass article, comprising:
providing a flat glass sheet;
forming at least one recess in a selected portion of the flat glass sheet that is to be shaped into a three-dimensional structure;
heat bending the flat sheet to form a desired shape, thereby creating a main body, the main body having an outer surface, the outer surface including at least one curved surface portion, the heat bending process enabling the at least one recess to be located at the at least one curved surface portion; and
forming at least one decorative member within the at least one receiving recess.

10. The method as claimed in claim 9, the at least one recess is formed by chemical etching.

11. The method as claimed in claim 9, the at least one recess is formed by laser engraving.

12. The method as claimed in claim 9, further comprising roughening a bottom surface of the at least one recess before the heat bending step.

13. The method as claimed in claim 12, the roughening step creates a surface roughness Ra of about 0.8 μm to about 1.0 μm for the bottom surface of the at least one recess.

14. The method as claimed in claim 9, further comprising chemically strengthening the main body after the heat bending step.

15. The method as claimed in claim 9, wherein the at least one decorative member is made from metal or wood.

16. The method as claimed in claim 15, wherein forming the at least one decorative member in the at least one recess includes previously manufacturing at least one decorative member from metal or wood and then securing the at least one decorative member in the at least one recess by adhesive.

17. The method as claimed in claim 9, wherein the at least one decorative member is made from an enamel material.

18. The method as claimed in claim 17, wherein forming the at least one decorative member in the at least one recess includes filling enamel powder in the at least one recess, and then sintering the enamel powder to form the at least one decorative member.

19. The method as claimed in claim 9, wherein the at least one decorative member is made from plastic; forming the at least one decorative member in the at least one recess includes previously manufacturing at least one decorative member from plastic and then securing the at least one decorative member in the at least one recess by adhesive.

20. The method as claimed in claim 9, wherein the at least one decorative member is made from plastic; forming the at least one decorative member in the at least one recess includes filling plastic powder in the at least one recess, and then sintering the plastic powder to form the at least one decorative member.
